(19) United States
(12) Patent Application Publication
(10) Pub. No.: US 2010/0088072 A1
(43) Pub. Date: Apr. 8, 2010

(54) SUPPORTING APPARATUS, DESIGN SUPPORTING METHOD AND RECORDING MEDIUM

(75) Inventors: Hirooki HAYASHI, Kawasaki (JP); Yukihiko FURUMOTO, Kawasaki (JP); Tsukasa TENMA, Kawasaki (JP); Yuichi ARITA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/571,971

(22) Filed: Oct. 1, 2009

(30) Foreign Application Priority Data
Oct. 2, 2008 (JP) 2008-257700

(51) Int. Cl. G06F 17/50

(52) U.S. Cl. 703/1

(57) ABSTRACT

A method and system of supporting design includes extracting basic shape data associated with CAD model data, extracting know-how data associated with the basic shape data, and associating the model data and the know-how data with each other and setting a degree of association between the model data and the know-how data.

### CROSS-REFERENCE TO RELATED APPLICATIONS

This application is based upon and claims the benefit of priority of the prior Japanese Patent Application No. 2008-257700, filed on Oct. 2, 2008, the entire contents of which are incorporated herein by reference.

### BACKGROUND

1. Field

The embodiments discussed herein relate to a design supporting apparatus using CAD (computer-aided design), a design method and a recording medium having a design supporting program.

2. Description of the Related Art

Today, a CAD system provided with specialized functions is utilized for each of fields, such as electricity, machine and architecture fields. For example, a CAD system is used for shape design of an electronic apparatus, logical design of a circuit and wiring design of a printed-circuit board, and furthermore, for shape design of a transportation apparatus or a building. In the case of designing a product using such a CAD system, design man-hours are reduced and the deadline for delivery is shortened, for example, by utilizing a model used in the past.

Japanese Laid-open Patent Publication No. 7-28882 relates to a CAD system, and discusses association among CAD data, document data where a keyword is defined in advance, and, by specifying the keyword, the associated CAD data or document data is provided. Japanese Laid-open Patent Publication No. 2007-148897 discusses an operation in which a CAD operation command and knowledge information are stored in association with each other to perform final arrangement of knowledge information.

### SUMMARY

According to an aspect of the invention, a method and system of supporting design includes extracting basic shape data associated with CAD model data, extracting know-how data associated with the basic shape data, and associating the model data with the know-how data and setting a degree of association between the model data and the know-how data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIGS. 1A to 1F are system configuration diagrams of a design supporting apparatus of an embodiment;

FIG. 2A is a diagram showing an example of a shape of a model and showing that the model is constituted by four shapes F1 to F4;

FIG. 2B is a diagram showing that only shapes F2 and F3 are stored in a basic shape DB, and the shapes F2 and F3 are added with, for example, the ID number R1 and stored as basic shapes R1;

FIG. 3A is a diagram showing an image of association between models and basic shapes and an image of association between the basic shapes and know-hows;

FIG. 3B is a diagram showing a configuration example of an association DB;

FIGS. 4A to 4B are diagrams illustrating association among a model, a basic shape and a know-how;

FIG. 5 is a flowchart illustrating processing of an embodiment;

FIGS. 6A to 6B are diagrams illustrating processing for selecting a utilizable model and requesting the model to be utilized;

FIGS. 7A to 7B are diagrams illustrating processing for searching an association DB on the basis of the ID number of the model and obtaining a basic shape ID list from the basic shape DB;

FIGS. 8A to 8B are diagrams illustrating processing for obtaining a list of know-how information corresponding to the basic shape ID numbers obtained from the association DB;

FIGS. 9A to 9B are diagrams illustrating processing for searching a know-how DB on the basis of the know-how ID numbers;

FIGS. 10A to 10B are diagrams illustrating processing for providing basic shapes and know-how information about the basic shapes for a CAD;

FIGS. 11A to 11B are diagrams illustrating processing for displaying basic shapes and know-how information on an output device of the CAD;

FIGS. 12A to 12B are diagrams illustrating processing for selecting know-how information which a designer wants to confirm;

FIGS. 13A to 13B are diagrams illustrating processing for displaying detailed know-how information and highlighting a relevant basic shape;

FIG. 14A is a diagram showing that a degree of association between a model and a know-how increases as more basic shapes are used for the model, and the importance degree of the know-how increases;

FIG. 14B is a diagram showing that, as for the degree of association between a basic shape and a know-how, when there are multiple basic shapes which realize a know-how, a basic shape which is used most frequently is estimated to be the most reliable;

FIG. 14C is a diagram relating to basic shapes and showing that, when a basic shape associated with multiple know-hows is applied to a certain model, it is necessary to be careful when modifying the basic shape;

FIGS. 15A to 15E are system configuration diagrams of a design supporting apparatus of an embodiment;

FIG. 16 is a flowchart illustrating processing of an embodiment;

FIG. 17 is a flowchart illustrating a processing of an embodiment;

FIGS. 18A to 18B are diagrams showing the configuration of the databases in an initial state;

FIGS. 19A to 19B are diagrams illustrating processing for obtaining a know-how list from the know-how DB and displaying the list on the CAD;

FIGS. 20A to 20B are diagrams illustrating processing for selecting a know-how which the designer utilizes;

FIGS. 21A to 21B are diagrams illustrating processing for reading basic shape information on the basis of an obtained ID number, from the basic shape DB and providing the information for the designer (client);

FIGS. 22A to 22B are diagrams illustrating processing for obtaining a list of basic shape ID's applied to a stored model and obtaining one basic shape ID from the basic shape ID list;

FIGS. 23A to 23B are diagrams illustrating processing for obtaining a know-how ID associated with a basic shape ID obtained from the association DB;

FIGS. 24A to 24B are diagrams illustrating processing for preferentially displaying a know-how which has been actually applied when a different designer requests a know-how list;

FIGS. 25A to 25E are system configuration diagrams of a design supporting apparatus of an embodiment;

FIG. 26 is a flowchart illustrating processing of an embodiment;

FIGS. 27A to 27B are diagrams showing a configuration of databases in an initial state;

FIGS. 28A to 28B are diagrams illustrating processing performed in response to a request to call a model which the designer wants to modify;

FIGS. 29A to 29B are diagrams illustrating processing performed in a case of deleting a basic shape applied to a model and instructing storage of the model;

FIGS. 30A to 30B are diagrams illustrating processing for obtaining a list of association degrees of basic shapes associated with a model, from the association DB;

FIGS. 31A to 31B are diagrams illustrating processing for decreasing a degree of association between a model and a basic shape when a number (z)<an association degree (y) is satisfied;

FIGS. 32A to 32B are diagrams illustrating processing for decreasing a degree of association between basic shape and a know-how when a number (z)<a association degree (y) is satisfied;

FIGS. 33A to 33B are diagrams illustrating processing for decreasing a degree of association between a model and a know-how when a number (z)<a association degree (y) is satisfied;

FIGS. 34A to 34B are diagrams illustrating processing for, when a different designer requests a know-how list, providing information in a state that know-hows have been reviewed, for the designer;

FIG. 35 is a configuration diagram of a computer (information processing apparatus) which executes the present invention according to an embodiment; and

FIG. 36 is a configuration diagram of a computer (information processing apparatus) which executes the present invention according to an embodiment.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Typically, when a designer performs design using CAD, he utilizes a model used in the past to reduce design man-hours and shorten the deadline for delivery, as described above. However, in the case of utilizing an existing model, it is not possible to guess the design intention from each of the shapes forming the model. Therefore, a great effort and a lot of time are required to judge the necessity of each shape in designing of a product.

For example, in designing a metal plate to be attached to a printed-circuit board, a great effort and a lot of time may be required because it is not known whether the shape of a metal plate is intended for shielding, heat radiation or reinforcement.

Furthermore, there may be a case that shapes used for an existing model was sensuously decided by a designer on the basis of his long experience (including based on individual decision). In such a case, it is difficult to digitize the shapes and the like used for the model and introduce them into design of a product.

Accordingly, the embodiments provide a design supporting apparatus, method and a design supporting program for associating a basic shape obtained by embodying a design intention, a reasoning for a design decision, a know-how and a model, and, in the case of a designer utilizing a model to which such basic shapes are applied, enabling the designer to judge whether or not to apply the basic shapes used for the model to be utilized, in a short time, by easily knowing the design intention (know-how) associated with each basic shape.

According to the embodiments, the above and other existing problems can be solved by providing a basic shape data extraction operation of extracting basic shape data associated with multiple model data which is stored as CAD information, a know-how extraction operation of extracting know-how data associated with the basic shape data, and an association degree setting operation of associating the model data and the know-how data with each other and setting a degree of association between the model data and the know-how data.

Due to such a configuration, it is possible for a designer to, when utilizing a model, easily know a know-how associated with each basic shape and judge whether or not to apply basic shapes used for the model to be utilized, in a short time.

The association degree setting operation is configured to set the association degree on, for example, the basis of a number of the same kind of basic shape data associated with the model data. The association degrees are updated when the model data is read, and the know-how data is displayed on the basis of the association degrees when the model data is referred to.

The configuration is made in a manner that, when the display is performed, know-how data with a higher association degree (rate) is displayed at a higher ranking so that the designer can preferentially refer to know-how information which has been actually applied and efficiently apply a know-how to a target model. On the contrary, know-how data with a lower association degree is displayed at a lower ranking so that the possibility of an obsolete know-how being applied to a model can be reduced to secure design quality.

The embodiments can be also achieved by providing a design supporting apparatus provided with a basic shape data extraction unit which extracts basic shape data associated with multiple CAD model data stored as CAD information, a know-how extraction unit which extracts know-how data associated with the basic shape data, and an association degree setting unit which associates the model data and the know-how data with each other and sets a degree of association between the model data and the know-how data.

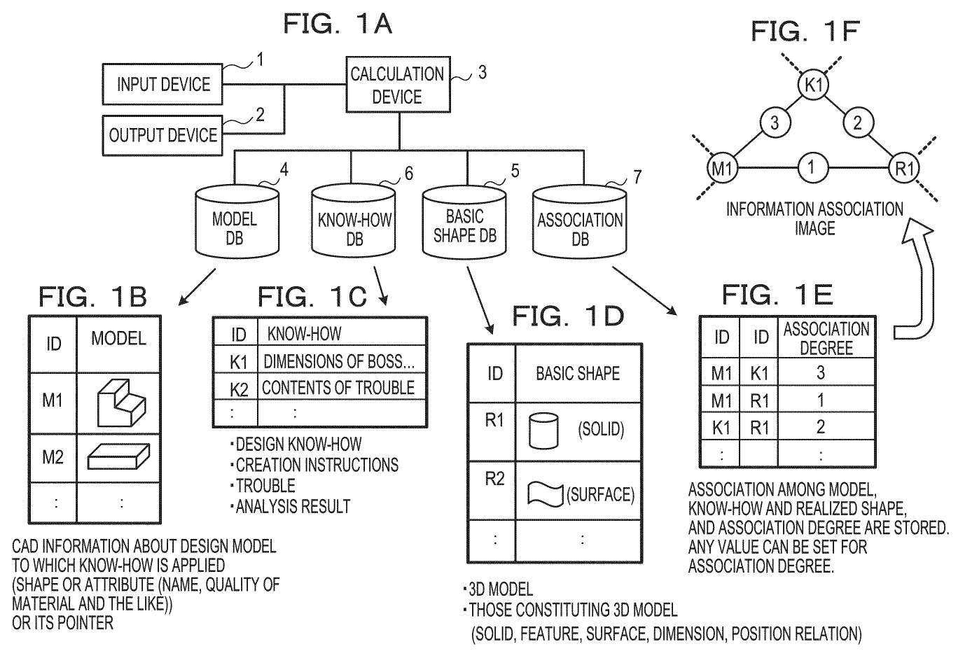

FIG. 1 is a system configuration diagram of a design supporting apparatus of an embodiment.

In the figure, the system is configured by an input device 1, an output device 2, a calculation device 3 and databases (DB's) e described in detail below. The input device 1 is, for example, a keyboard and mouse connected to a computer, and the output device 2 is, for example, the display of the computer.

The calculation device 3 is configured by a CPU, a ROM and a RAM described in detail below. To the calculation device 3, there are connected a model database (hereinafter referred to as a model DB) 4, a basic shape database (hereinafter referred to as a basic shape DB) 5, a know-how database (hereinafter referred to as a know-how DB) 6 and an association database (hereinafter referred to as an association DB) 7.

Here, in the model DB 4, there is stored a lot of model information which is design models used by developers when they perform product design, which satisfies functions necessary from the viewpoint of products, and which has been accumulated within a facility or by each development group, as CAD information. An ID number is given to each model stored in the model DB 4. For example, ID numbers of M1, M2, . . . shown in FIG. 1 are given.

A basic shape is a shape for realizing a know-how. In the basic shape DB 5, there is stored information such as solids, surfaces, features, dimensions, position relations, and the like. An ID number is also given to each basic model stored in the basic shape DB 5. For example, ID numbers R1, R2, . . . shown in FIG. 1 are given. Here, the basic shape of the ID number R1 is a cylindrical solid which identifies a boss, and the basic shape of the ID number R2 is a surface which identifies, for example, an analysis curved surface. A rectangular parallelepiped, a prism or the like may be identified as a solid, and a more complicated free-form surface may be identified as a surface.

Among shapes constituting a model, a shape which does not have a design meaning (know-how) may exist. However, in this embodiment, shapes stored in the basic shape DB 5 as basic shapes are only those which have a design meaning as described above.

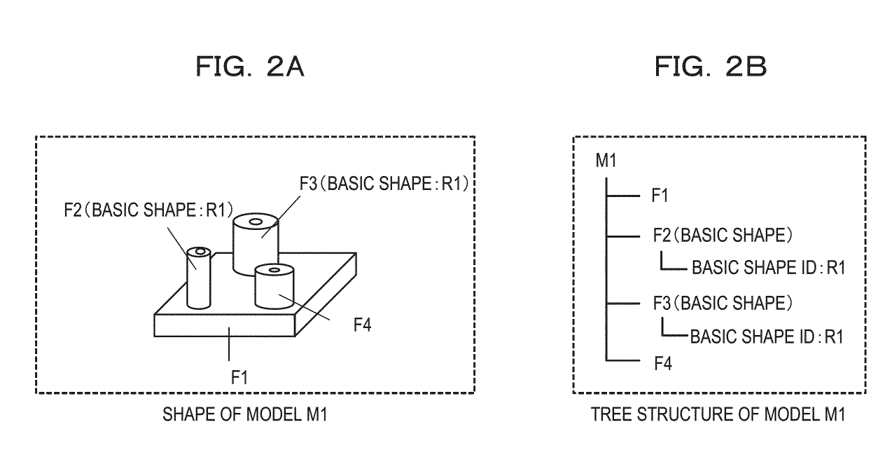

FIGS. 2A and 2B illustrate this relation. FIG. 2A shows, for example, a model M1. The model M1 is configured by four shapes F1 to F4. The shapes F2 and F3 have a design meaning which identifies the dimensions of a boss or the like, and the shapes F1 and F4 do not have a design meaning. Therefore, in this case, only the shapes F2 and F3 of the model M are stored in the basic shape DB 5, and, for example, the ID number R1 is given to them, as shown in FIG. 2B.

On the other hand, a know-how is a candidate for information to be referenced to design a model, and the design intentions of the basic shapes described above are stored in the know-how DB 6. For example, design know-hows and information about troubles, analysis results and the like are stored therein. An ID number is also given to each item stored in this know-how DB 6. For example, in the case of a know-how K1 shown in FIG. 1, it is about the dimensions of a boss, and in the case of a know-how K2, a concrete example of the contents of a trouble is described. While a few exemplary information pertaining to design know-hows stored in the DB 6 are described herein, the present invention is not limited thereto and may store any information pertaining to and driving a design decision.

In the association DB 7, association between the model and the basic shape, association between the basic shape and the know-how, and each association degree are stored. For example, as the degree of association between the model and the basic shape, the number of basic shapes used for the model is set.

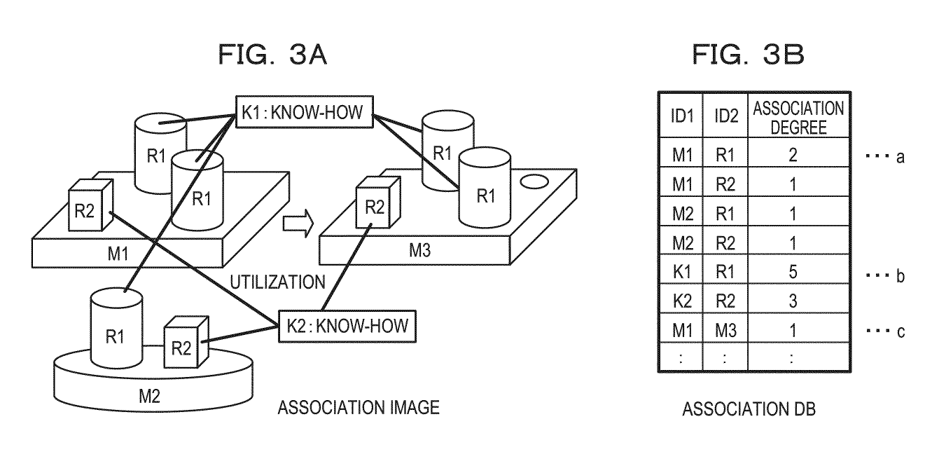

FIG. 3 is a diagram illustrating meaning of an association and an association degree described above. FIG. 3A shows an image of association between models and basic shapes and an image of association between the basic shapes and know-hows, and FIG. 3B shows the configuration of the association DB 7 for the association images. In the example shown in FIG. 3A, two basic shapes R1 and one basic shape R2 are applied to the model M1, one basic shape R1 and two basic shapes R2 are applied to the model M2, and two basic shapes R1 and one basic shape R2 are applied to the model M3. The basic shape R1 has a know-how with the ID number K1, and the basic shape R2 has a know-how with the ID number K2.

In this case, in the association DB 7 shown in FIG. 3B, “2”, the number of the basic shapes R1 used as described above, is set as the degree of association between the model M1 and the basic shape R1 (a shown in FIG. 3B). As the degree of association between the model M1 and the basic shape R2, “1”, the number of the used basic shapes R2 is set. Similarly, as for the model M2 also, the number of the used basic shapes R1 “1” is set as the degree of association between the model M2 and the basic shape R1, and the number of the used basic shapes R2 “1” is set as the degree of association between the model M2 and the basic shape R2.

Five basic shapes R1 for realizing the know-how K1 are used for the models described above, and therefore, the degree of association between the basic shape R1 and the know-how K1 is set to “5” (b shown in FIG. 3B). Similarly, “3” is set as the degree of association between the basic shape R2 and the know-how K2. Furthermore, the association degree “1” indicating that the model M1 is utilized for the model 3 is set in the association DB 7 (c shown in FIG. 3B). As for the utilization of the model M1, the association is performed, for example, by the calculation device 3 confirming the ID number of the model M1 included in the model M3 when performing processing of the model M3.

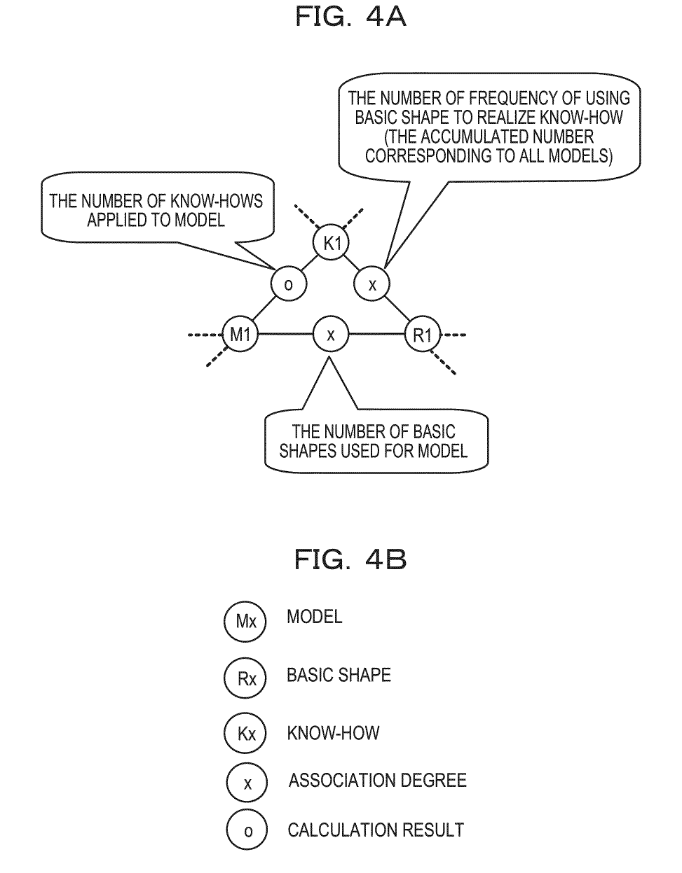

The association between a model and a basic shape can be indicated by a triangle as shown in FIG. 4. A model (for example, the model M1), a basic shape (for example, the basic shape R1) and a know-how (for example, the know-how K1) are positioned at the apexes. The degree of association between the model M1 and the basic shape R1 is set on the line connecting the model M1 and the basic shape R1, and the degree of association between the basic shape R1 and the know-how K1 is set on the line connecting the basic shape R1 and the know-how K1. Furthermore, the degree of association between the model M1 and the know-how K1 is set on the line connecting the model M1 and the know-how K1. These association degrees can be determined by calculation on the basis of the relation described above. In A in FIG. 1, an example is shown in which the association degrees are the numerical values shown in the figure.

The processing operation of an embodiment under the above configuration is described in detail below.

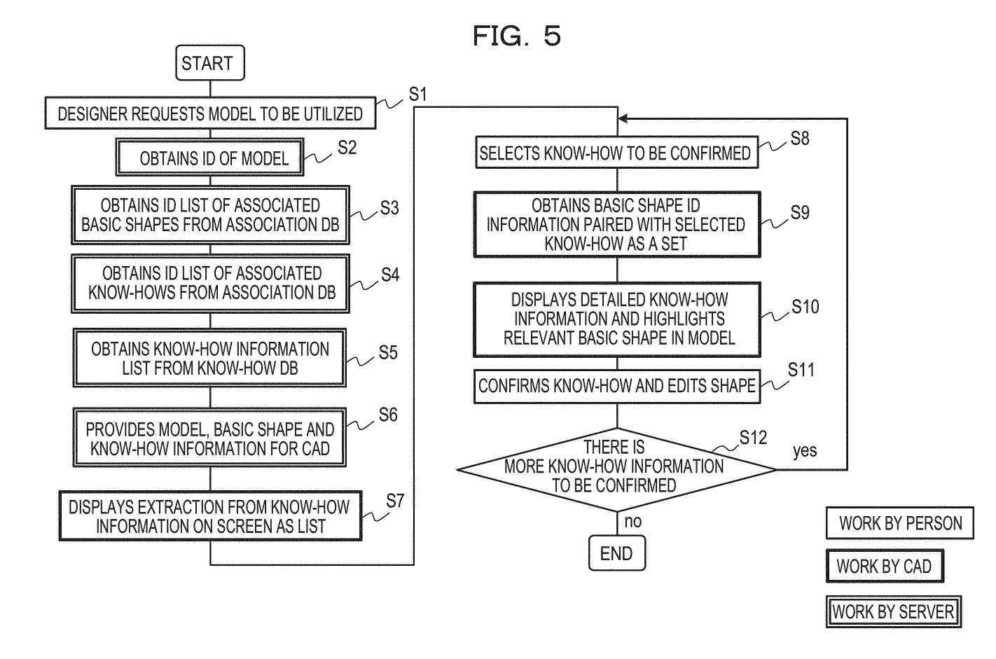

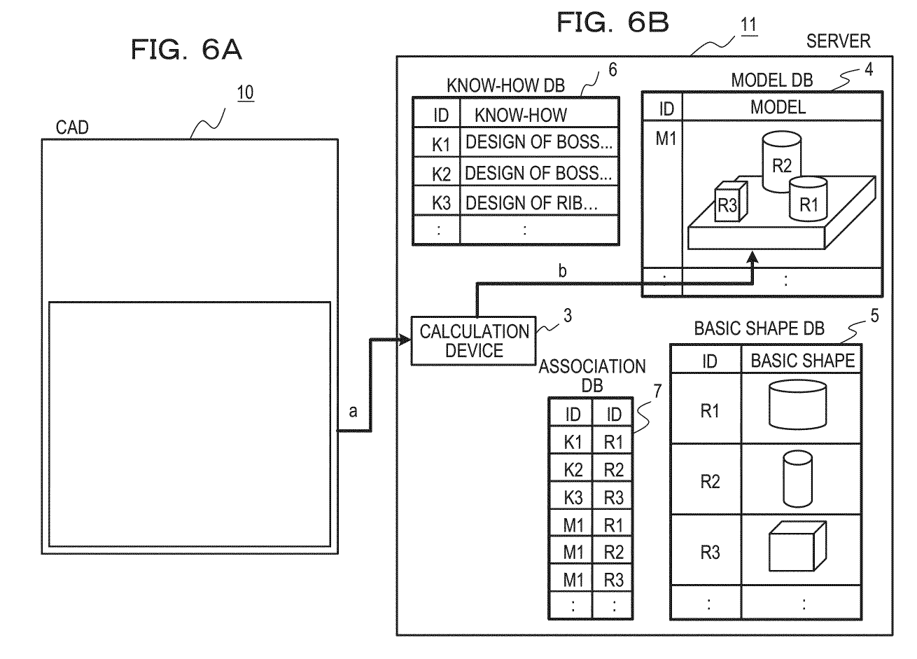

FIG. 5 is a flowchart illustrating a processing of an embodiment. FIGS. 6 to 13 are diagrams illustrating processing flows corresponding to the flowchart. Before the processing of an embodiment is started, the model DB 4, the basic shape DB 5, the know-how DB 6 and the association DB 7 shown in FIG. 6 are constructed in a server 11.

When a designer performs product design, he first selects a utilizable model and requests the model to be utilized from the server (operation (hereinafter abbreviated as S) 1). FIG. 6 is a diagram illustrating processing on the server 11 side when the request is made. In the figure, the input device 1 and the output device 2 described before are provided on the CAD 10 side, and the calculation device 3 and the databases such as the model DB 4 are provided on the server 11 side.

The request by the designer is sent from the CAD 10 to the calculation device 3 (a shown in FIG. 6). The calculation device 3 searches the model DB 4 on the basis of the request (b shown in FIG. 6) and obtains the ID number of the requested model (for example, the model M1) (S2).

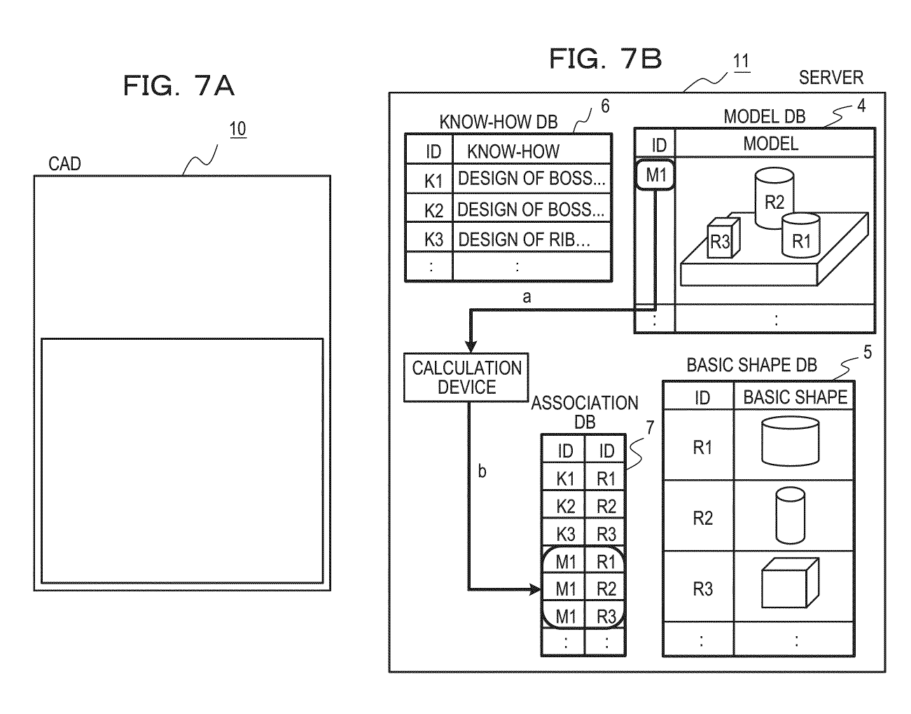

Next, the calculation device 3 searches the association DB 7 on the basis of the obtained ID number, and obtains, for example, an ID list of basic shapes associated with the model M1 from the basic shape DB 5 (S3). FIG. 7 is a diagram illustrating this processing. For example, if the model M1 is selected (a shown in FIG. 7), the ID list (ID numbers) of basic shapes associated with the model is obtained, from the association DB 7 (b shown in FIG. 7). In the example shown in the figure, the ID numbers of the basic shapes R1, R2 and R3 associated with the model M1 are obtained.

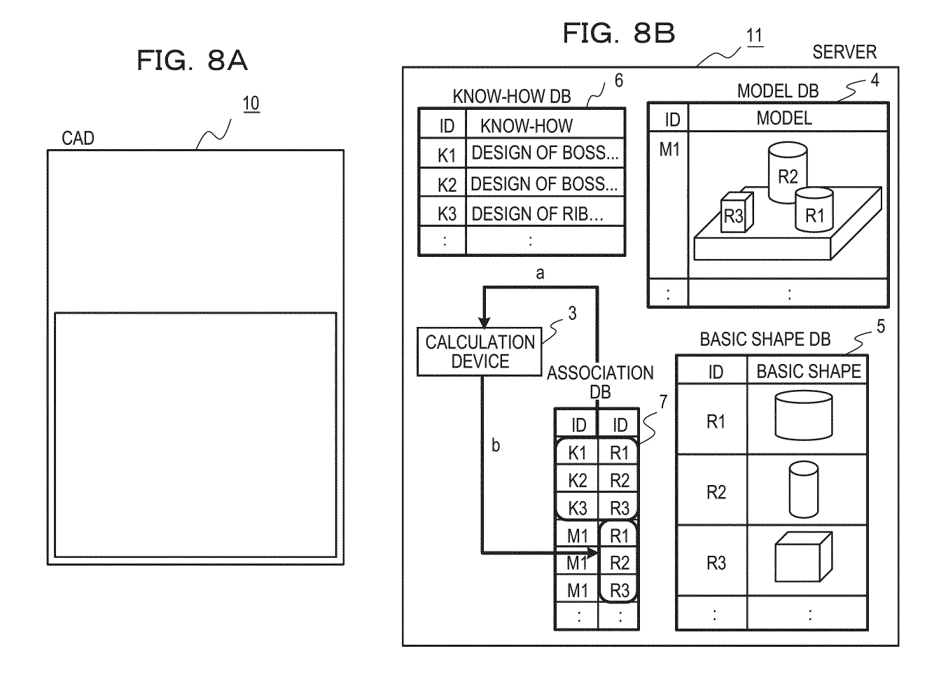

Next, an ID list of know-hows corresponding to the obtained basic shape ID numbers, from the association DB 7 and the know-how DB 6 (S4). FIG. 8 is a diagram illustrating this processing. For example, an ID list (ID numbers) of know-hows corresponding to the basic shapes R1 to R3 is obtained (a and b shown in FIG. 8). In the example shown in the figure, the ID number K1 is obtained for the basic shape R1, the ID number K2 is obtained for the basic shape R2, and the ID number K3 is obtained for the basic shape R3.

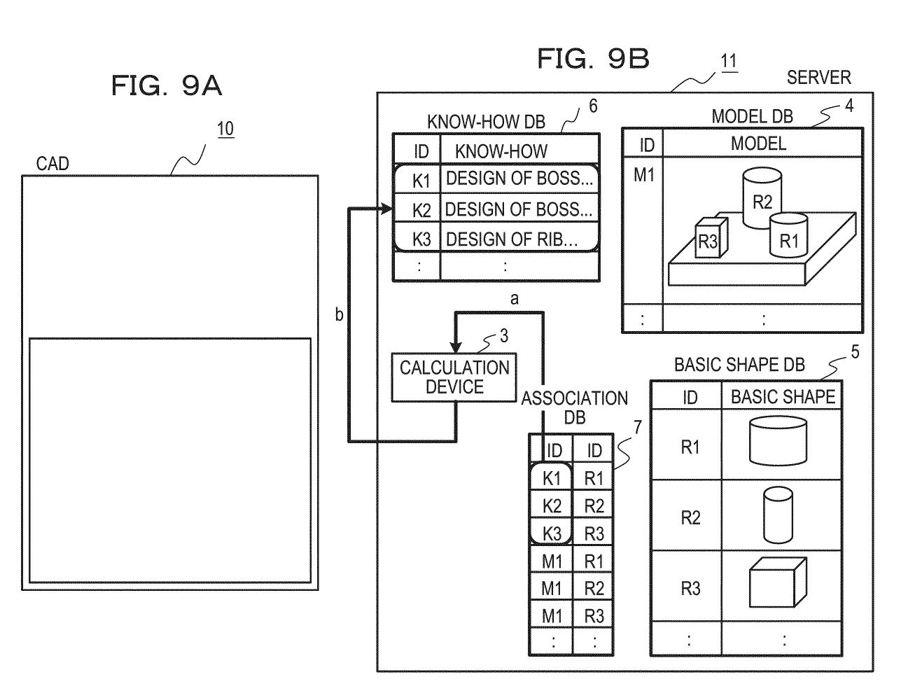

Next, the know-how DB 6 is searched on the basis of the ID numbers K1 to K3 to obtain a know-how information list (S5). FIG. 9 is a diagram illustrating this processing. A know-how list, that is, the ID numbers K1 to K3 are read from the association DB 7 (a shown in FIG. 9), and the know-how DB 6 is searched (b shown in FIG. 9) to obtain corresponding information of the know-hows K1 to K3, for example, information such as design of boss . . . , design of rib . . . , and the like from the know-how DB 6.

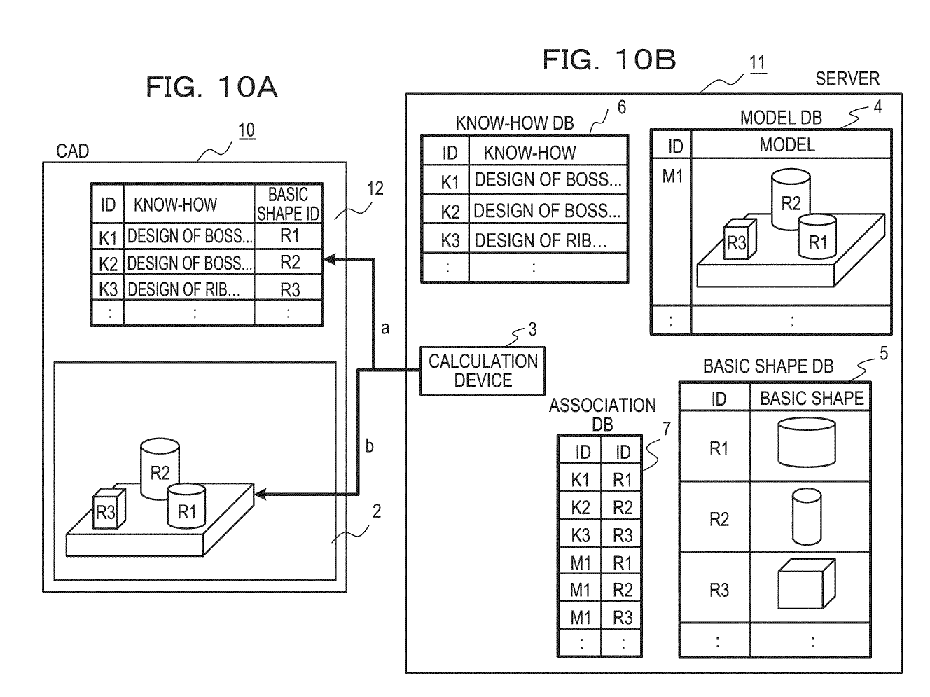

Next, the calculation device 3 provides the model, the obtained basic shapes, the know-how information associated with the basic shapes for the CAD 10 (S6). FIG. 10 is a diagram illustrating this processing. The calculation device 3 transmits, for example, the basic shapes R1 to R3 corresponding to the model, and the information of the know-hows K1 to K3 to the CAD 10 (a and b shown in FIG. 10) and stores them into a memory area 12 of the CAD 10.

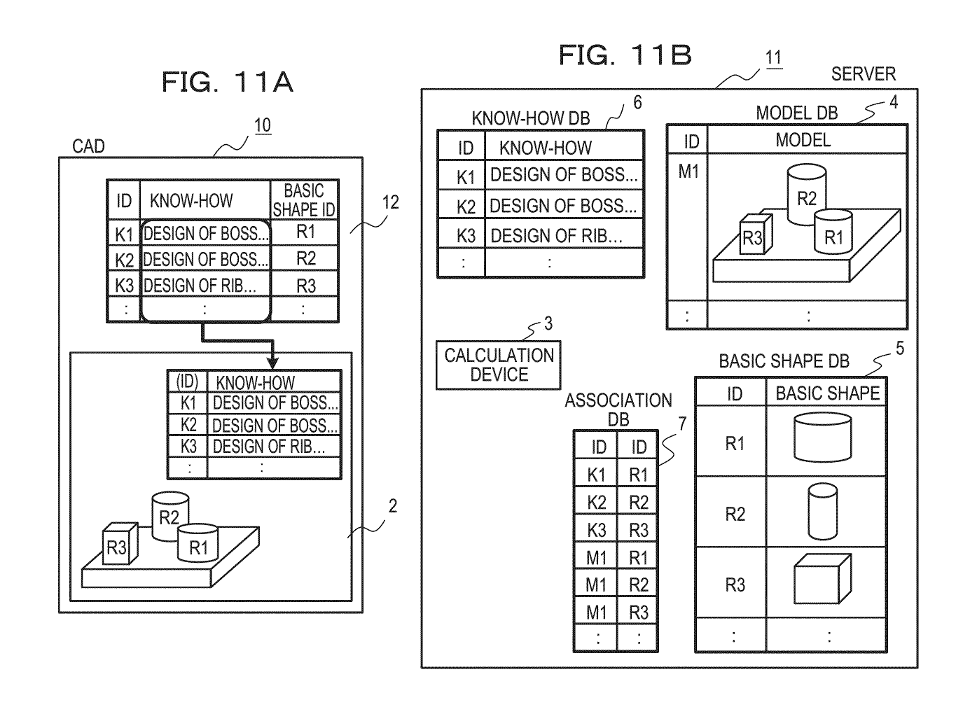

The information described above is displayed on the output device 2 (display) as a list (S7). FIG. 11 is a diagram illustrating this processing. The know-how information stored in the memory area 12 is read and displayed on the output device 2. In the example shown in the figure, the external appearance of the model M1 is displayed. A design know-how, for example, about a boss is displayed as the know-hows K1 and K2, and a design know-how about a rib is displayed as the know-how 3.

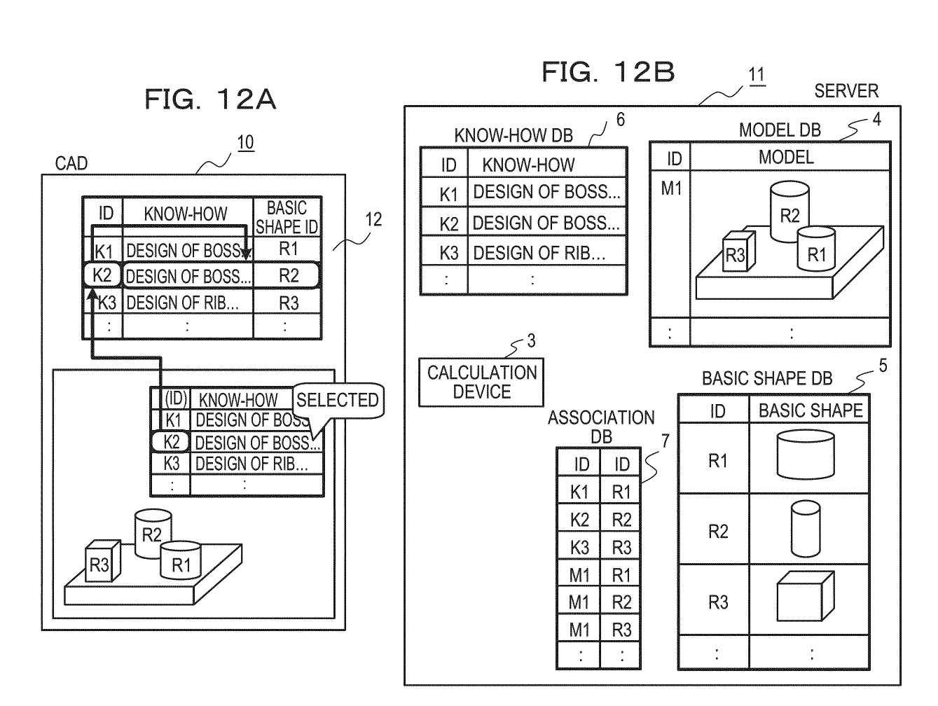

Next, the designer refers to the displayed know-how information and selects know-how information which he wants to confirm (S8). FIG. 12 is a diagram illustrating this processing. The know-how selected by the designer, for example, the know-how K2 is highlighted.

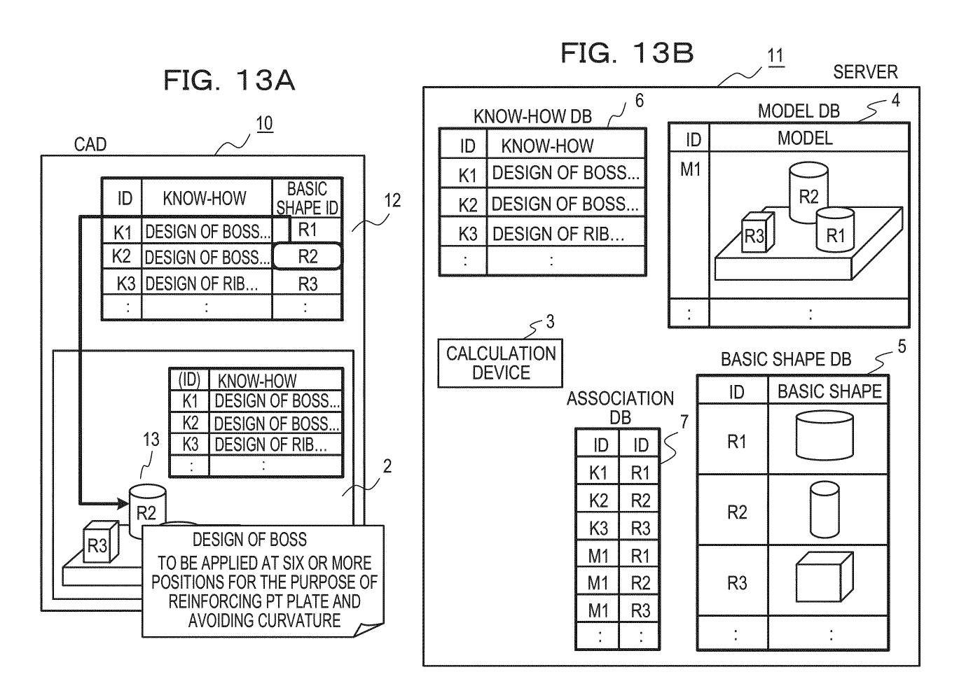

Next, basic shape ID information paired with the selected know-how information as a set is obtained on the basis of the selection by the designer (S9). Furthermore, detailed know-how information is displayed, and a relevant basic shape is highlighted (S10). FIG. 13 is a diagram illustrating this processing. For example, if the selected know-how ID number is K2, the detailed information “information about design of boss, that is, bosses should be at six or more positions for the purpose of reinforcing a Pt plate and avoiding curvature of the Pt plate” is displayed, and the basic shape R2 is highlighted, as shown in the FIG. 13 shown in FIG. 13).

Thus, when applying the basic shape R2, the designer does not have to do work such as inquiry about the meaning of (reason for) applying the basic shape R2 to the model M1 of a different designer because the design meaning of using the basic shape is displayed on the display, and therefore, he can perform shape decision in a short time (S11).

In the case where there is more know-how information to be confirmed (S12: YES), it is possible to display know-how information corresponding to the basic shape R1 and perform shape decision by performing processing similar to the above (S8 to S11).

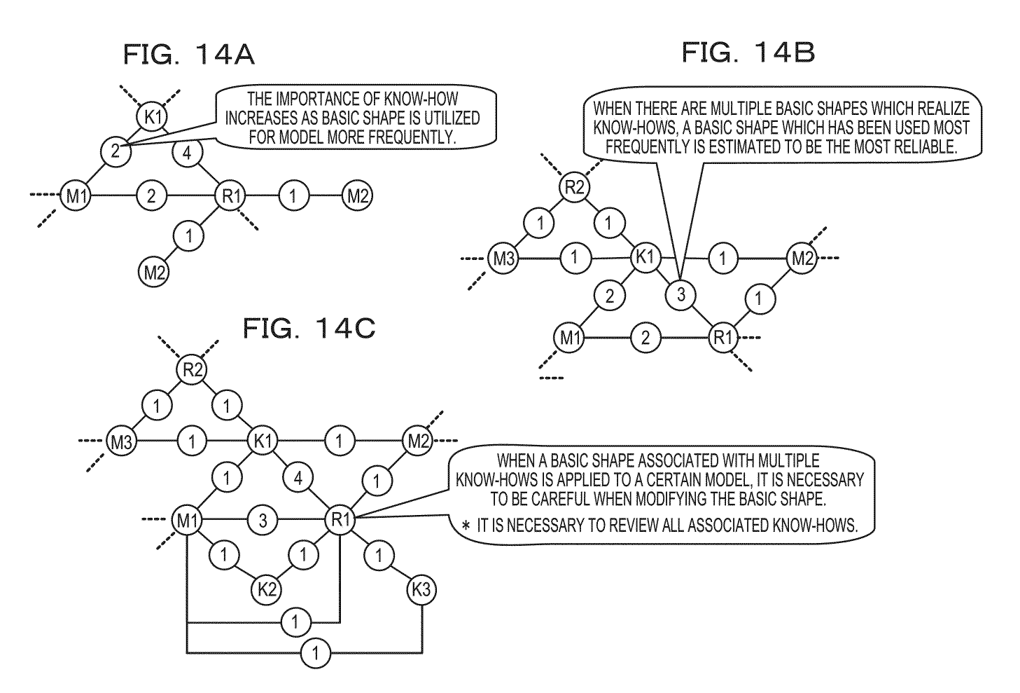

FIG. 14 is a diagram showing at least one advantage about the association among models, basic shapes and know-hows, in which the triangles with a model, a basic shape and a know-how positioned at apexes, described before in FIG. 4, are combined. For example, FIG. 14A shows that, the degree of association between a model (for example, the model M1) and a know-how (for example, the know-how K1) increases as the number of basic shapes used for the model increases, and the importance degree of the know-how (for example, the know-how K1) increases.

FIG. 14B shows that, as for the degree of association between a basic shape (for example, the basic shape R1) and a know-how (for example, the know-how K1), when there are multiple basic shapes which realize know-hows), a basic shape used most frequently (having the highest association degree) is estimated to be the most reliable among the multiple basic shapes. Furthermore, FIG. 14C shows that, as for a basic shape (for example, the basic shape R1), when a basic shape associated with multiple know-hows is applied to a certain model, it is necessary to be careful when modifying the basic shape. The reason is that, in this case, it is necessary to consider all the associated know-hows.

Next, another embodiment is described.

When a list of design know-hows is provided for a designer, it is important to preferentially display a know-how which has been actually applied. However, in the case of deciding a priority order simply on the basis of the frequency of designers having accessed the know-hows in the past, concrete know-how utilization is not clear. Therefore, an embodiment makes it possible to automatically perform review and preferentially display a know-how which has been actually applied so that a designer can use a know-how which has been actually applied. Specific description is made below.

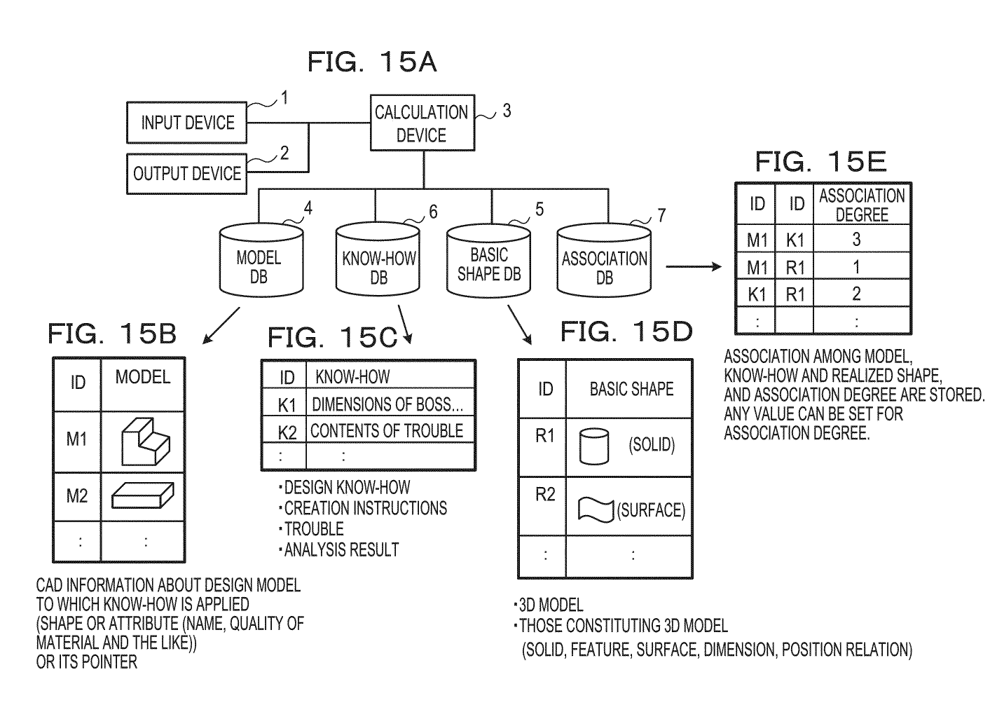

FIG. 15 is a system configuration diagram of a design supporting apparatus of an embodiment. Similar to the embodiment described before, this system is also configured by the input device 1, the output device 2 and the calculation device 3. Furthermore, the model DB 4, the basic shape DB 5, the know-how DB 6 and the association DB 7 are connected to the calculation device 3. The calculation device 3 has a memory for temporary storage inside. Similarly to the above description, a lot of model information which is design models used by developers for product design and which has been accumulated within a facility or by each development group is stored in the model DB 4, being attached with ID numbers M1, M2, . . . .

In the basic shape DB 5, there is stored information such as solids, surfaces, features, dimensions, position relations and the like constituting the models, similarly being attached with ID numbers R1, R2, . . . . Among parts constituting a model, a part which does not have a design meaning may exist. However, in this embodiment also, parts stored in the basic shape DB 5 are only those which have a design meaning as described above, similarly as described above.

The know-how DB 6 is configured to store design know-hows, troubles, analysis results of the basic shapes described above, and ID numbers K1, K2, . . . are given similarly as described before. For example, the dimensions, the contents of troubles and the like of a boss in the case of using the basic shapes described above are stored. Furthermore, in the association DB 7, associations between the models and the basic shapes, associations between the basic shapes and the know-hows, and the association degrees are stored.

The processing operation of this embodiment under the above configuration is described in detail below.

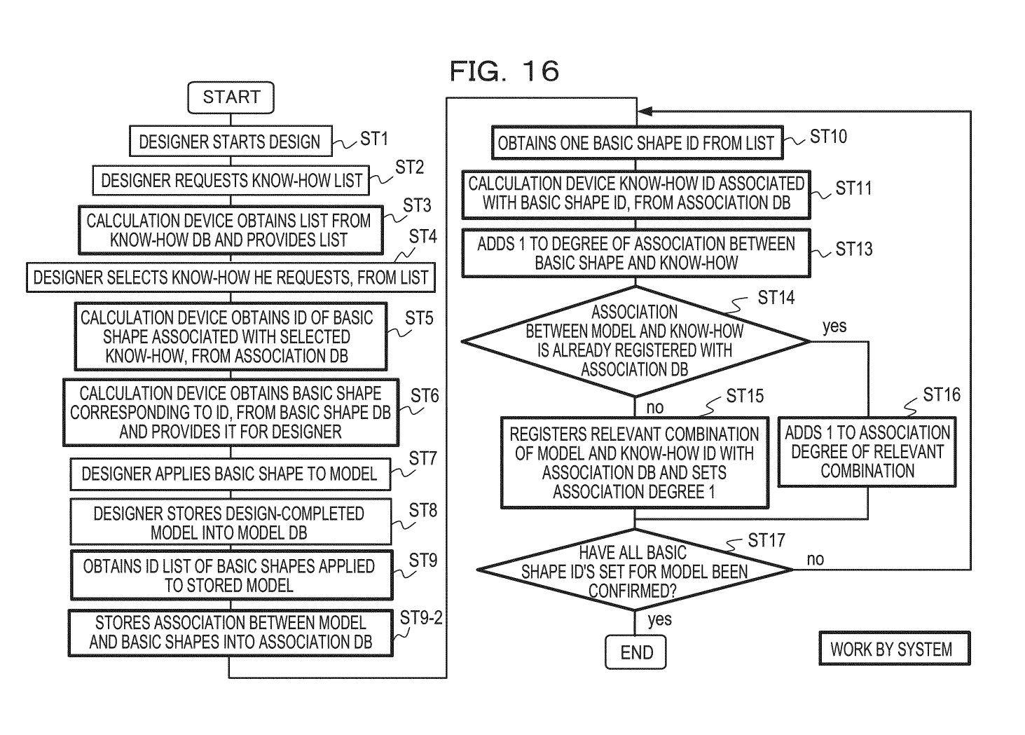

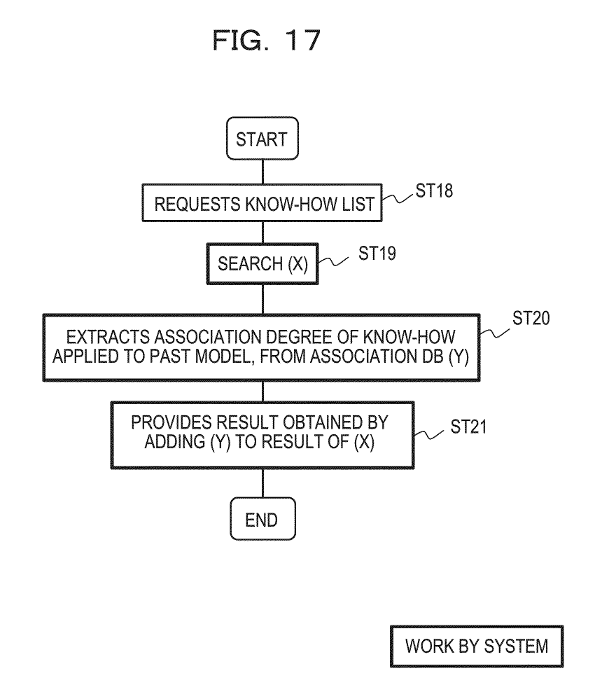

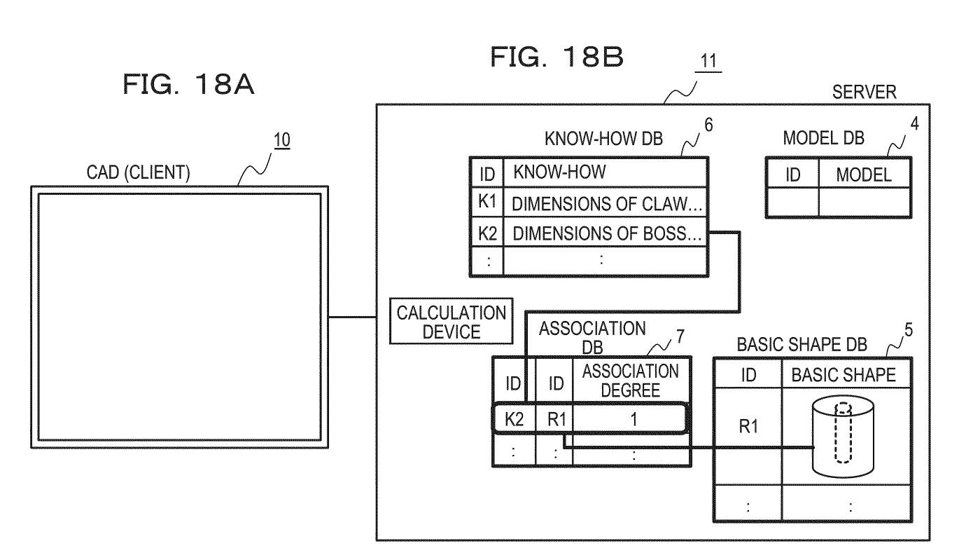

FIGS. 16 and 17 are flowcharts illustrating processing of an embodiment. Before the processing of this embodiment is started, the model DB 4, the basic shape DB 5, the know-how DB 6 and the association DB 7 shown in FIG. 18 are constructed in the server 11.

First, in the flowchart shown in FIG. 16, for example, a designer starts design while displaying a model (operation (hereinafter abbreviated as ST) 1). Then, he requests a know-how list, for example, to apply a know-how to a certain model (ST2). This request is transmitted from the CAD 10 to the calculation device 3 on the server 11 side.

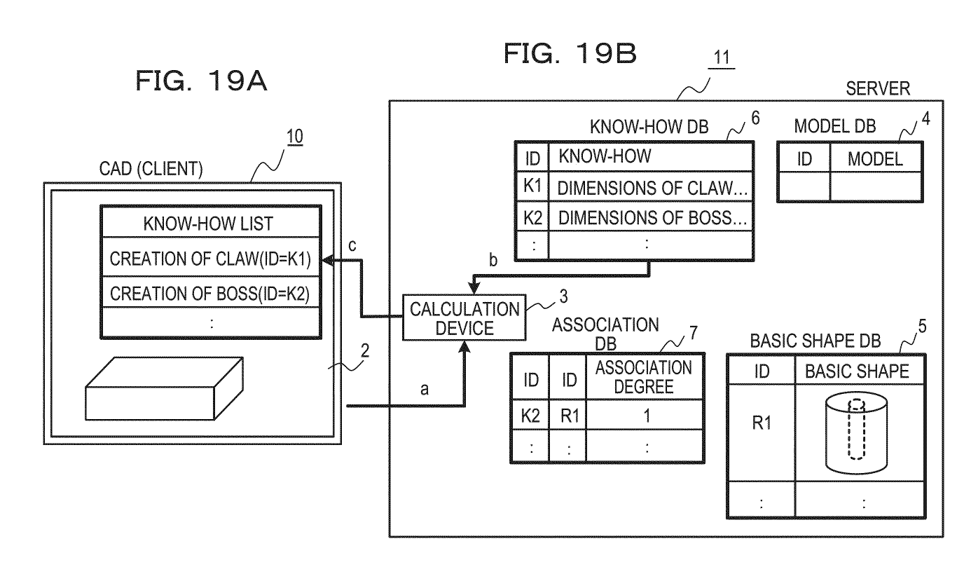

Receiving the request, the calculation device 3 obtains the know-how list from the know-how DB 6 and provides it for the CAD 10 (ST3). FIG. 19 is a diagram illustrating the above processing. When a know-how list is requested by the CAD (client) 10 (a shown in FIG. 19), the calculation device 3 obtains the know-how list from the know-how DB 6 (b shown in FIG. 19) and transmits the know-how list to the CAD (client) 10 (c shown in FIG. 19). By this processing, the know-how list shown in the figure is displayed on the output device 2.

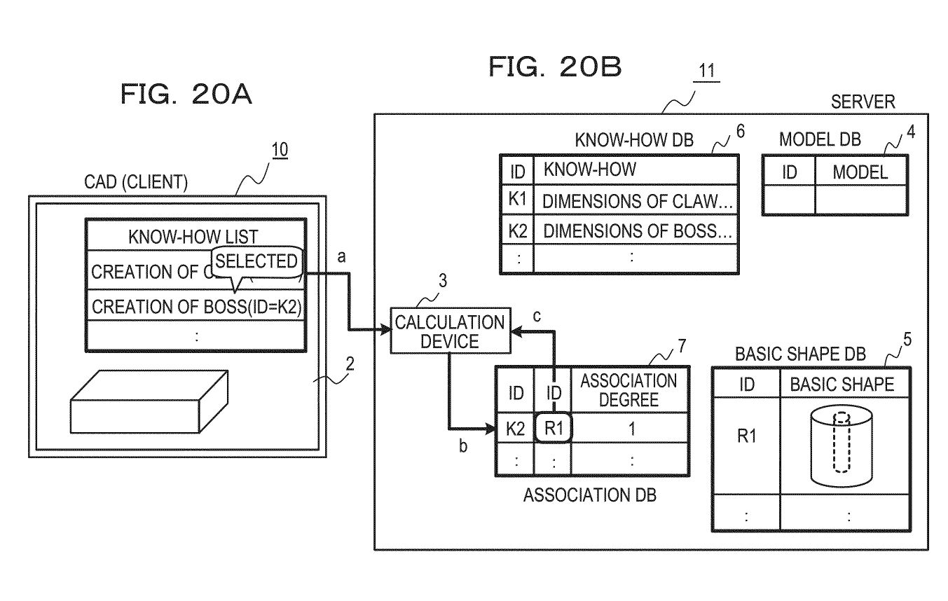

Next, the designer refers to the displayed know-how list and selects a know-how he wants to request (ST4). FIG. 20 is a diagram illustrating this processing. For example, information such as creation of claw (ID=K1), creation of boss (ID=K2) and the like is displayed. If the designer selects, for example, creation of boss (ID=K2) in this state as shown in the figure, the selected information is transmitted to the calculation device 3 (a shown in FIG. 20). The calculation device 3 searches the association DB 7 in accordance with the selected information which has been transmitted (b shown in FIG. 20) and obtains the ID number of the basic shape R1 which is associated with the selected “creation of boss” (ID=K2) from the association DB 7 (ST5; c shown in FIG. 20).

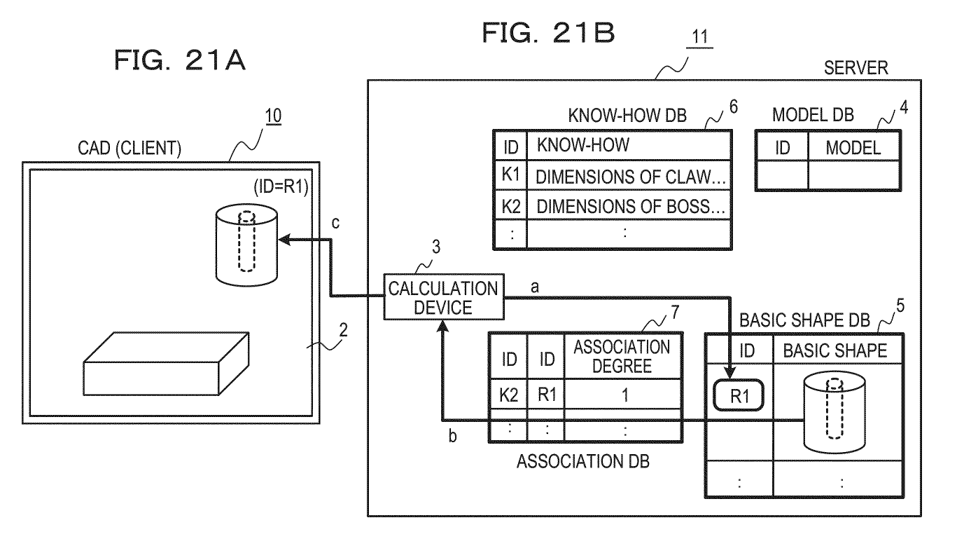

Basic shape information based on the ID number obtained in this way is read from the basic shape DB 5 by the calculation device 3 and provided for the designer (client) (ST6). FIG. 21 is a diagram illustrating this processing. The calculation device 3 searches the basic shape DB 5 on the basis of the obtained ID number (a shown in FIG. 21), reads basic shape information corresponding to, for example, the ID number R1 (b shown in FIG. 21), and transmits the basic shape information to the designer (client) (c shown in FIG. 21). By this processing, the basic shape information corresponding to the know-how is displayed on the output device 2 as shown in FIG. 21.

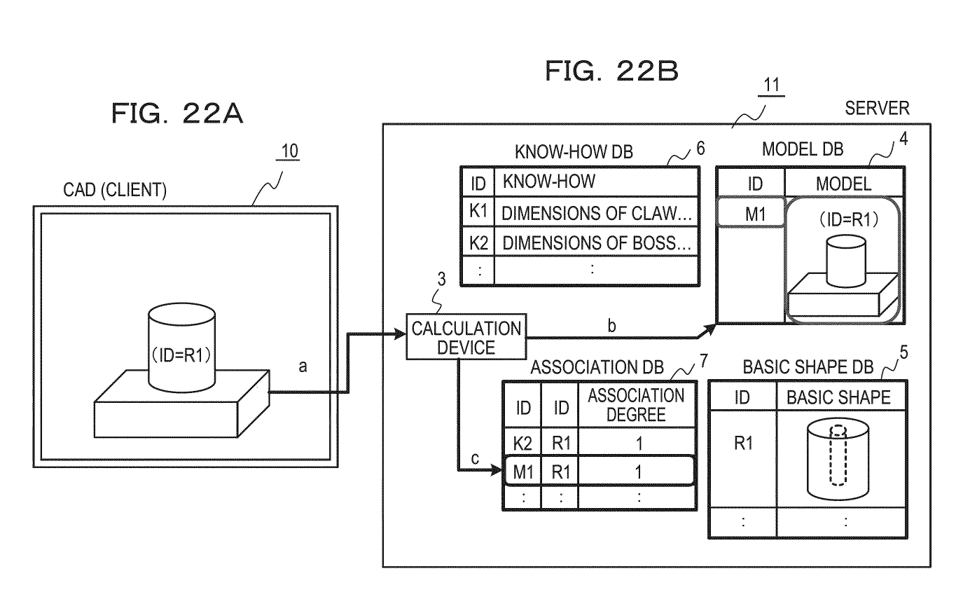

Next, if the designer thinks that the provided basic shape (for example, the basic shape R1) can be applied to the model he is designing, he applies the basic shape to the model (ST7). After that, when the design is completed, the completed model is stored into the model DB 4 (ST8). In this processing, as shown in FIG. 22, when information about the completed model is obtained from the designer (client) side (a shown in FIG. 22), the calculation device 3 stores the information into the model DB 4 (b shown in FIG. 22).

Next, the calculation device 3 stores the newly stored model into the model DB 4, with M1 specified as its ID, obtains a list of the basic shape ID's applied to the model (ST9), and registers the ID's with the association DB 7 (ST9-2) (c shown in FIG. 22). M1 and the basic shape ID list are stored in the memory area of the calculation device 3.

Next, one basic shape ID is obtained from the basic shape ID list stored in the memory (ST10). Furthermore, a know-how ID associated with the obtained basic shape ID, from the association DB 7 (ST11).

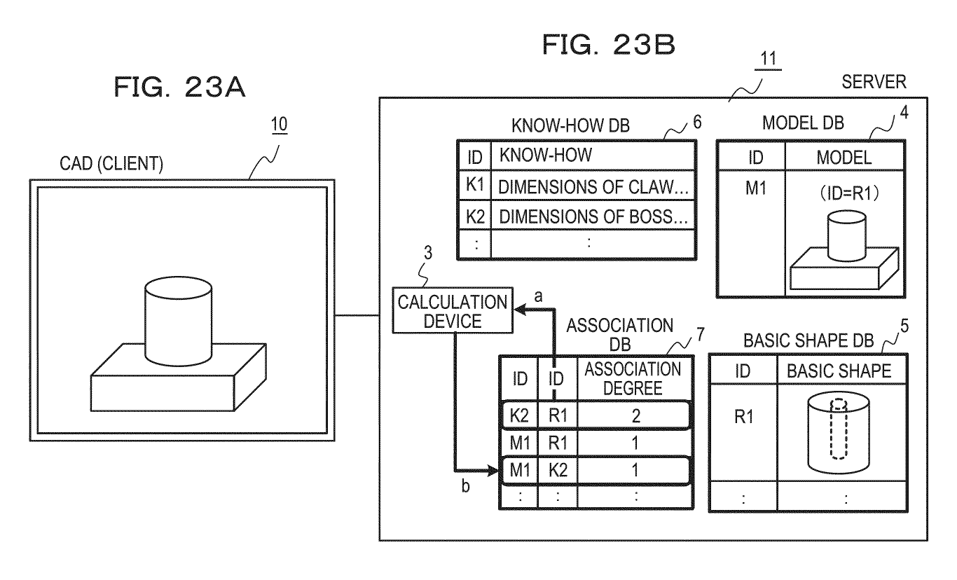

Next, 1 is added to the degree of association between the basic shape and the know-how (ST13). For example, in the case of the basic shape R1, 1 is added to the degree of association between the basic shape R1 and the know-how K2 in the association DB 7 as shown in FIG. 23, so that the association degree is “2” shown in FIG. 23 (a shown in FIG. 23). Furthermore, it is judged whether association between the model and the know-how is already registered with the association DB 7 (ST14). If it is not registered yet (ST14: NO), the combination of the model and the know-how is registered with the association DB 7, and the association degree is set to “1” (ST15). For example, in the example shown in FIG. 23, the combination of the model ID M1 and the know-how K2 stored in the memory is registered with the association DB 7, and the association degree is set to “1” (b shown in FIG. 23).

If the association between the model and the know-how is already registered with the association DB 7 (ST14: YES), 1 is added to the corresponding association degree between the model and the know-how (ST16).

After that, it is judged whether the processing has been performed for all the basic shapes set for the model (ST17). If the processing has not been performed for all the basic shapes, the above processing (ST10 to ST16) is repeated. When the processing is completed for all the basic shapes (ST17: YES), the processing is ended.

By performing the processing as described above, the calculation device 3 provides a know-how list for a different designer when he requests the know-how list as described before, and the know-how list provided in this case is such that know-hows which have been actually applied to models are displayed in descending order of association degrees.

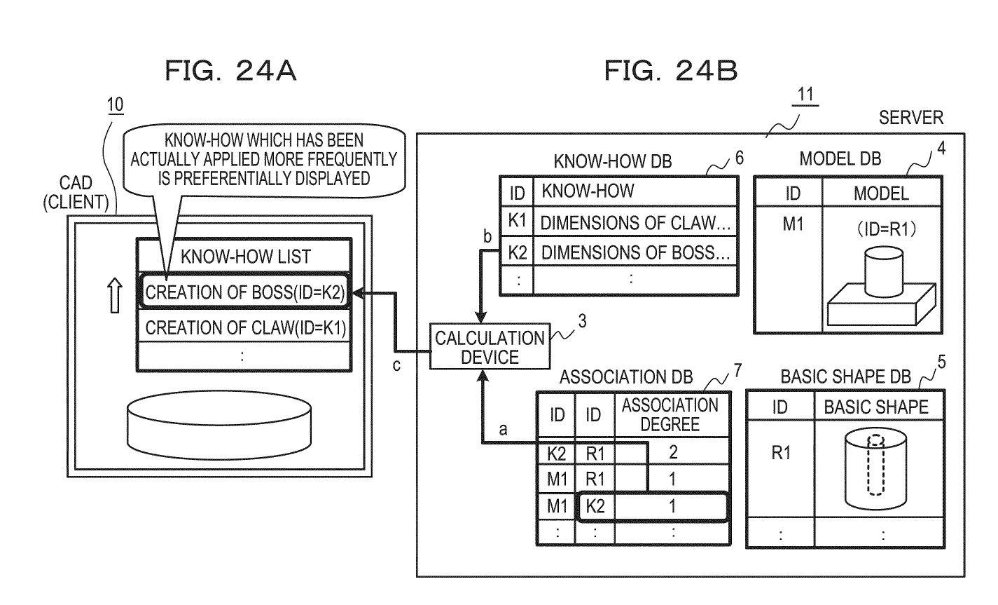

FIG. 17 is a flowchart illustrating this processing. FIG. 24 is a diagram illustrating a concrete flow of the processing. First, when a designer requests a know-how list (ST18), the calculation device 3 searches the know-how DB 6 for know-hows (X) (S19). In this case, narrowing down by keyword or the like may be performed. Next, association degrees of know-hows applied to past models are extracted (Y) (S20), and a result obtained by adding the association degrees of the know-hows (Y) to the search result (X) is provided (S21).

For example, in the example of FIG. 24, the calculation device 3 obtains corresponding know-hows from the know-how DB 6 (X) (b shown in FIG. 24), extracts the association degrees of the know-hows applied to models (Y) from the association DB 7 (a shown in FIG. 24), adds the association degrees (Y) to (X), and transmits the result to a designer (client) (c shown in FIG. 24). In this case, know-hows are displayed on the output device 2 in a descending order of association degrees (rate of usage). That is, a know-how which has been actually applied (or used) is displayed at a higher ranking. The method and system of supporting design thus include associating shape data selected during design of a target model with know-how data stored from previous designs that use the shape data and ranking reasons for design decisions in the previous designs based on a condition such as a degree of association or usage) and displaying the reasons according to the ranking.

Thus, according to this embodiment, a know-how which has been actually applied is preferentially displayed at a higher ranking in a know-how list. Therefore, when a designer refers to the know-how list, he can efficiently judge whether or not to apply a know-how and shorten the time required for product design.

Next, another embodiment is described.

It brings about deterioration of design quality to grasp a know-how which has not been actually utilized recently even if the know-how is information stored in the know-how DB 6. Therefore, in this embodiment, such a know-how as has been utilized less frequently is reviewed, and, when a basic shape is deleted, a know-how and the like which are associated with the basic shape are also deleted, in order to improve the design quality. Specific description will be made below.

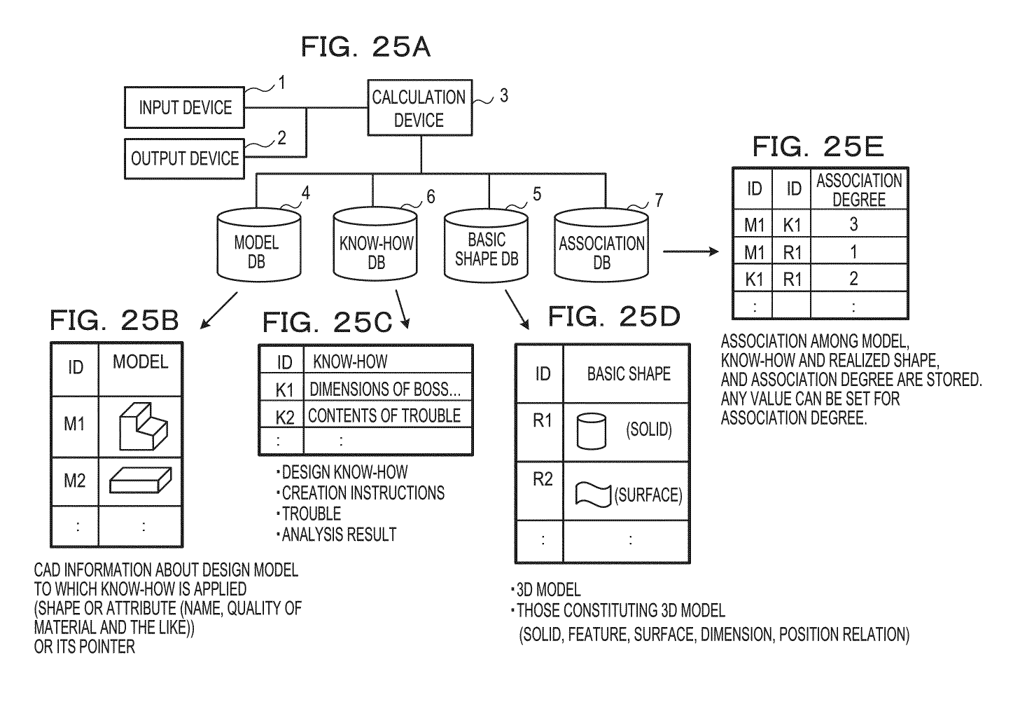

FIG. 25 is a system configuration diagram of a design supporting apparatus of this embodiment. The configuration of this system is also basically the same as those embodiments described above, and is configured by the input device 1, the output device 2 and the calculation device 3, and furthermore, the model DB 4, the basic shape DB 5, the know-how DB 6 and the association DB 7 are connected to the calculation device 3. Here, information stored into the model DB 4, the basic shape DB 5, the know-how DB 6 and the association DB 7 is similar to that in the embodiments described above. In the model DB 4, there are stored models used for production design. In the basic shape DB 5, there is stored information such as solids and surfaces constituting the models, features, dimensions and position relations. In the know-how DB 6, there are stored design know-hows, troubles, analysis results and the like for the basic shapes. In the association DB 7, there are stored association between the models and the basic shapes, association between the basic shapes and the know-hows, and association degrees.

The processing operation of this embodiment under the above configuration is described below in detail.

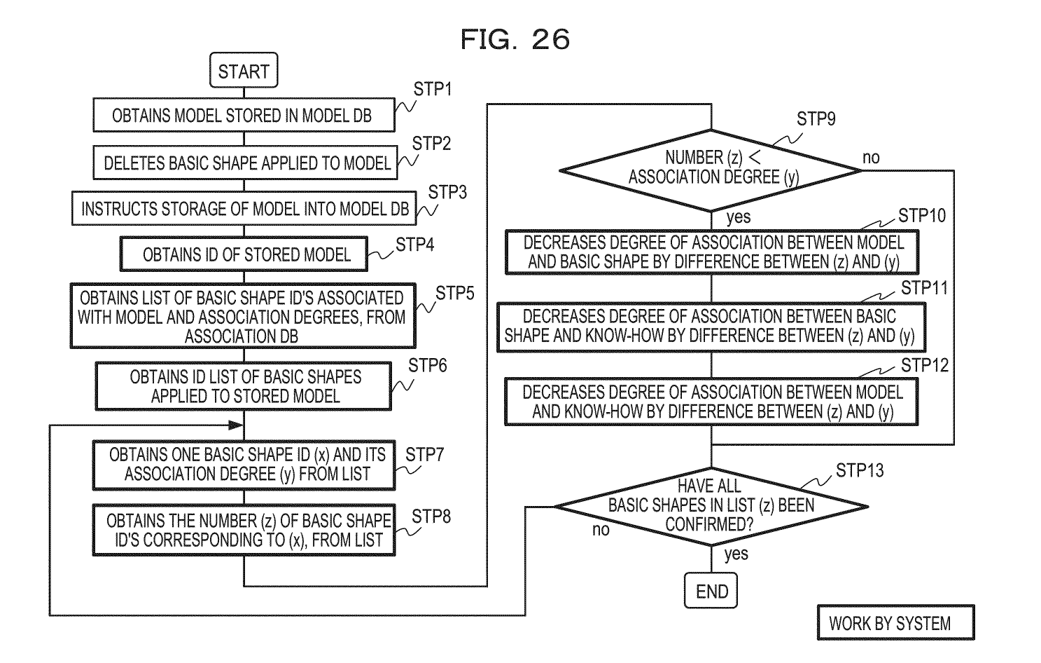

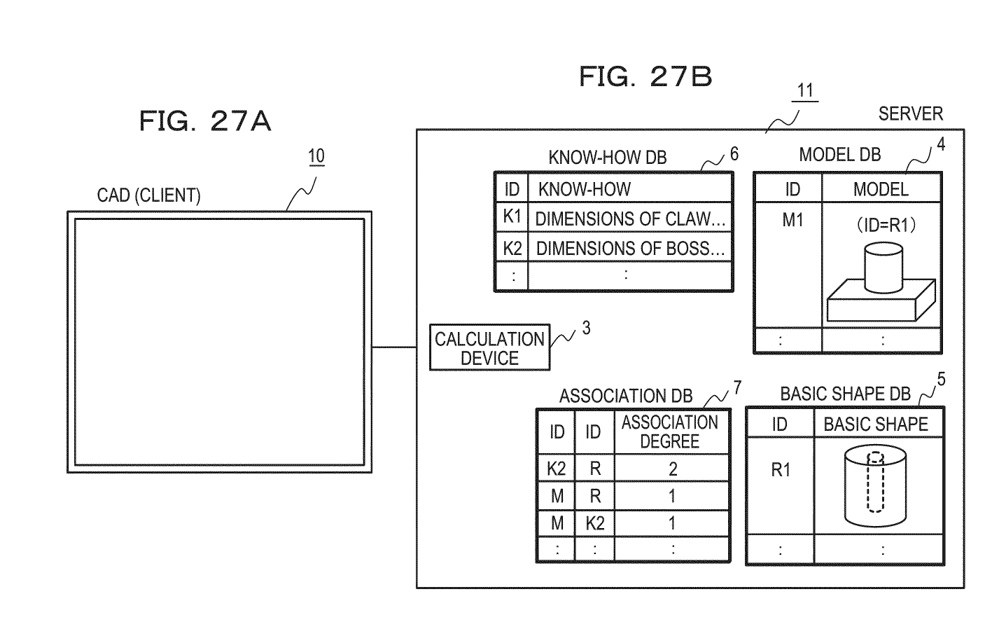

FIG. 26 is a flowchart illustrating a processing of an embodiment. It is assumed that, before the processing of this embodiment is started, the model DB 4, the basic shape DB 5, the know-how DB 6 and the association DB 7 shown in FIG. 27 are constructed in the server 11.

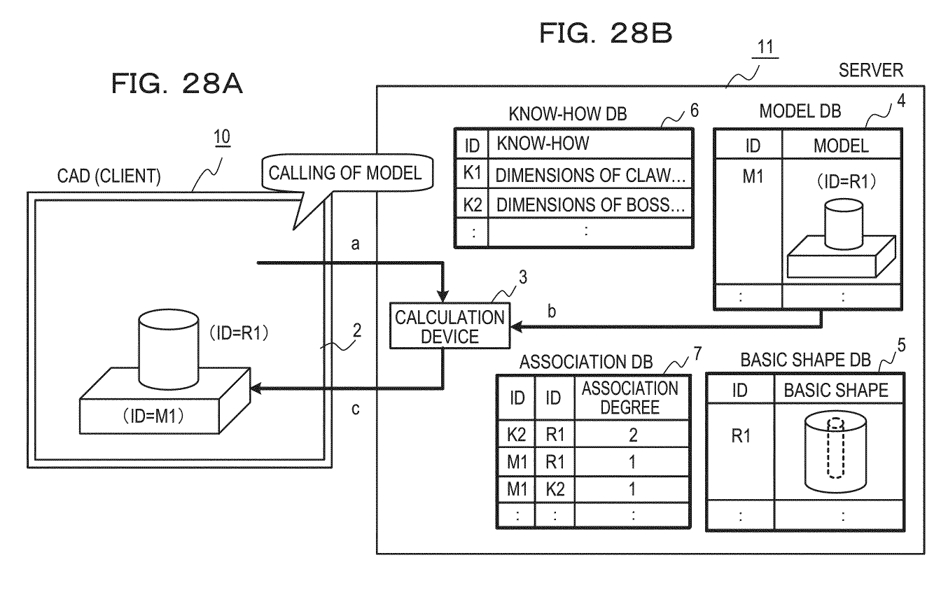

First, a designer requests to call a model which he wants to modify, and obtains the model stored in the model DB 4 (operation (hereinafter abbreviated as STP) 1). FIG. 28 is a diagram illustrating this processing. When the designer requests to call a model which he wants to modify from the calculation device 3 (a shown in FIG. 28), the calculation device 3 searches the model DB 4 and reads information of the requested model (for example, the model M1) (b shown in FIG. 28). Then, the calculation device 3 transmits the information of the model to the designer (c shown in FIG. 28). By this processing, for example, the display shown in the figure is displayed on the output device 2.

Next, the designer checks the display, deletes a basic shape (for example, the basic shape R1) applied to the model (STP2), and instructs storage of the model (for example, the model M1) (STP3).

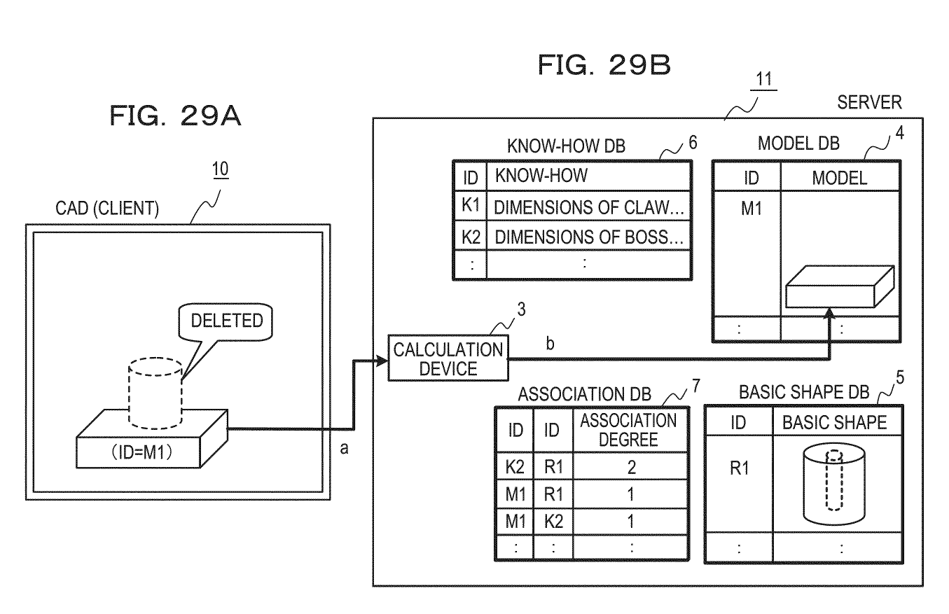

The calculation device 3 first obtains a corresponding model ID number on the basis of this instruction (STP4). FIG. 29 is a diagram illustrating this processing. When the instruction is given from the designer (a shown in FIG. 29), the calculation device 3 stores the model information from which a basic shape of the relevant ID number (for example, the basic shape R1) in the model DB 4 has been deleted (b shown in FIG. 29), and performs succeeding processing on the basis of the above ID number.

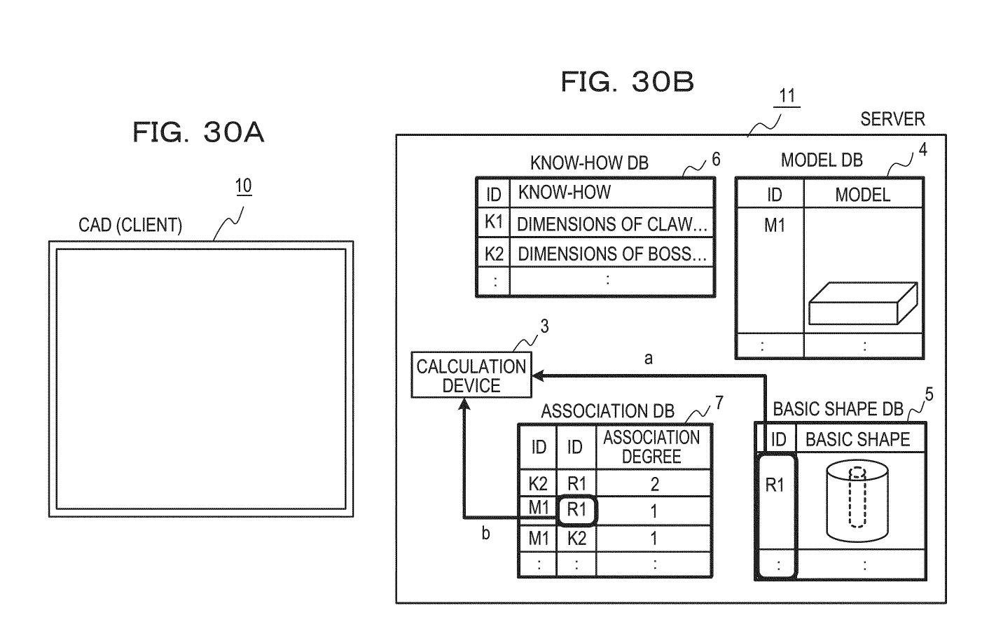

First, a list of association degrees (a) of basic shapes associated with the model (for example, the model M1) is obtained from the association DB 7 (STP5). FIG. 30 is a diagram illustrating this processing. The association DB 7 is searched, and list information (a) about association degrees of basic shapes (for example, the basic shape R1) is obtained (b shown in FIG. 30). In this case, it is confirmed whether the ID is registered with the basic shape DB 5 (a shown in FIG. 30).

Next, an ID list of basic shapes applied to the stored model (b) is obtained (STP6), and one of the basic shape ID's (x) and information about its association degree (y) is obtained from the list (a) (STP7). Furthermore, the number of basic shape ID's (z) corresponding to the one of the basic shape ID's (x) is obtained from the list (b) (STP8). Then, the number (z) and the association degree (y) are compared in magnitude (STP9).

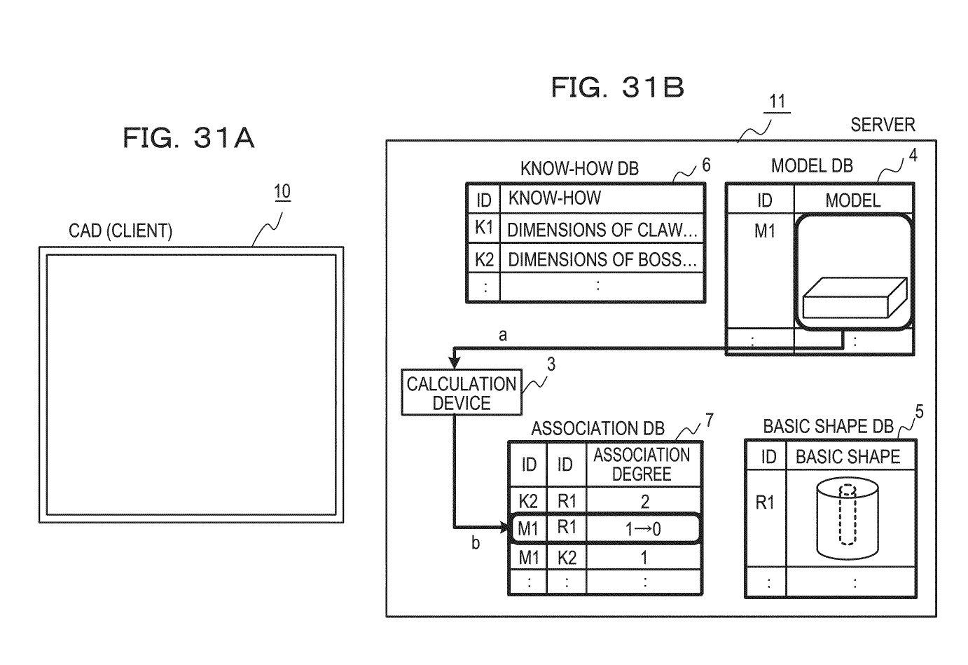

Here, when the number (z)<the association degree (y) is satisfied, it is judged that the use frequency of the basic shape has decreased, and the degree of association between the model and the basic shape is decreased by the difference between the number (z) and the association degree (y) (STP10). FIG. 31 is a diagram illustrating this processing. The calculation device 3 obtains a list of ID's of basic shapes applied to the model (b) (in the case of FIG. 31, a basic shape does not exist) (a shown in FIG. 31), and the association degree between the model (for example, the model M1) and the basic shape (for example, the basic shape R1) in the association DB 7 is decreased from “1” to “0” on the basis of the above calculation method (b shown in FIG. 31).

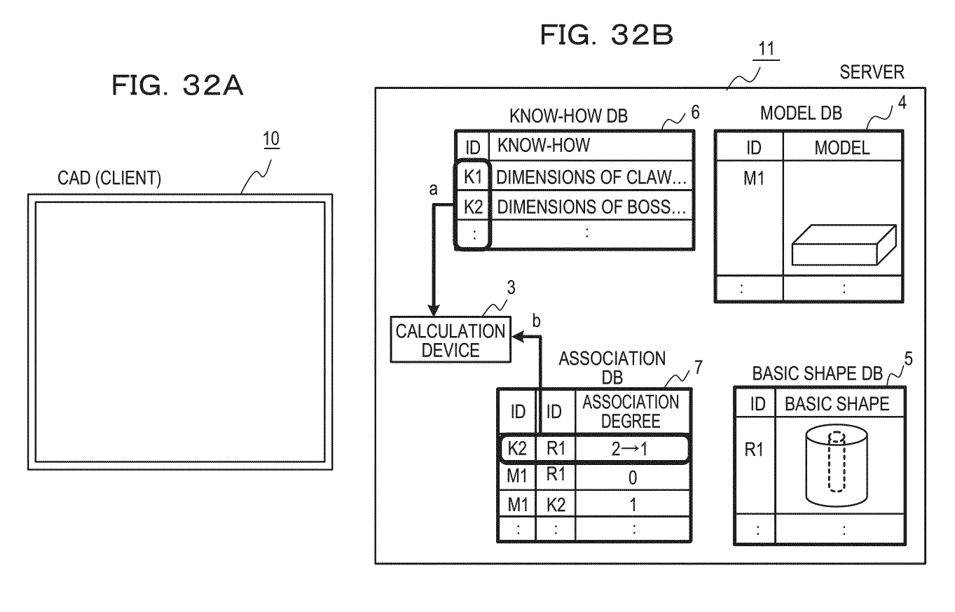

Next, the degree of association between the basic shape and the know-how is decreased by the difference between the number (z) and the association degree (y) (STP11). FIG. 32 is a diagram illustrating this processing. The calculation device 3 decreases the degree of association between the know-how (for example, the know-how K2) and the basic shape (for example, the basic shape R1) in the association DB 7 from “2” to “1” (b shown in FIG. 32). In this case, it is confirmed whether there is a know-how ID for which the association degree is to be decreased, in the know-how DB 6 (a shown in FIG. 32).

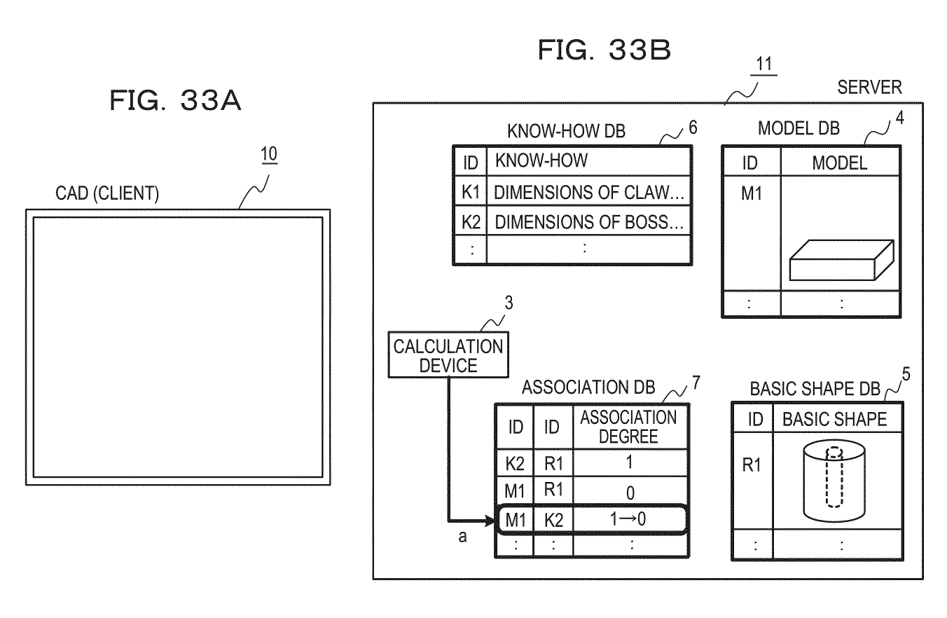

Furthermore, the degree of association between the model and the know-how is decreased by the difference between the number (z) and the association degree (y) (STP12). FIG. 33 is a diagram illustrating this processing. The calculation device 3 decreases the degree of association between the model (for example, the model M1) and the know-how (for example, the know-how K2) in the association DB 7 from “1” to “0” (a shown in FIG. 33).

Next, it is judged whether all the basic shapes in the list have been confirmed (STP13). If all the basic shapes have not been confirmed (STP13: NO), the above processing is repeated (STP7 to STP12). After that, when confirmation for all the basic shapes is completed (STP13: YES), the processing is ended.

By the above processing, the degree of association between the model and the basic shapes, the degree of association between the basic shapes and the know-hows, and the degree of association between the model and the know-hows are reviewed, and the databases are updated to be databases in which, for example, obsolete know-hows have been reviewed. In this state, when a designer requests a know-how list next time, information in which know-hows have been reviewed can be provided for the designer.

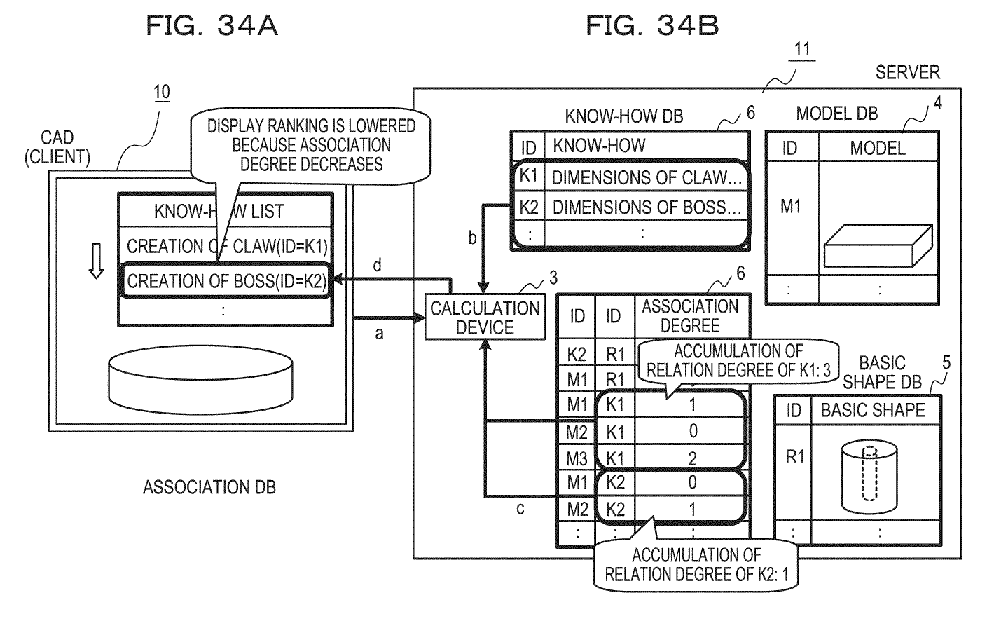

FIG. 34 is a diagram illustrating this processing. When receiving a request for a know-how list from the designer (client) (a shown in FIG. 34), the calculation device 3 reads the know-how list from the know-how DB 6 (b shown in FIG. 34), further searches the association DB 7 (c shown in FIG. 34), and displays the know-how list on the output device 2 (d shown in FIG. 34). In this case, in the display of the know-how list, such a know-how that accumulation of the association degree is large is displayed at a higher ranking, and such a know-how that accumulation of the association degree is small, that is, a know-how which has not been used frequently is displayed at a lower ranking, on the basis of association degree accumulations obtained from the association DB 7. For example, as shown in the figure, since the association degree of the know-how K2 has decreased as described above, its display ranking is lowered.

According to such a configuration, the display ranking of obsolete information which has been used less frequently is lowered. Therefore, in the case of a designer checking a know-how list to use past design information, the possibility of using an obsolete know-how can be reduced.

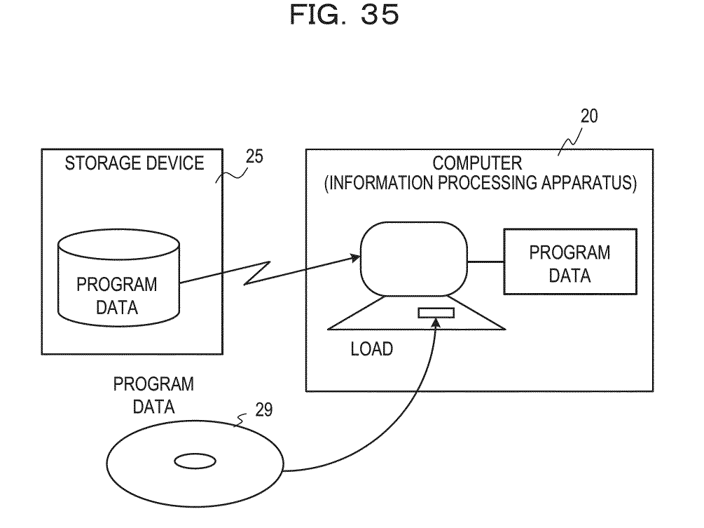

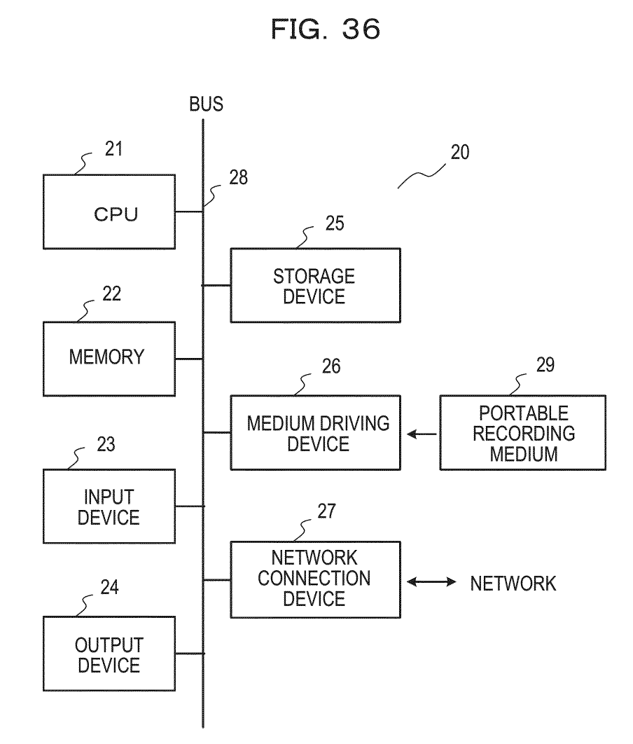

The processing described in embodiments above can be also executed by a computer (information processing apparatus) 20 configured as shown in FIGS. 35 and 36. The computer 20 shown in both figures is provided with a CPU 21, a memory 22, an input device 23, an output device 24, a storage device 25, a medium driving device 26, and a network connection device 27, which are connected with one another via a bus 28.

The memory 22 includes, for example, a ROM (read-only memory), a RAM (random access memory) and the like and stores a program and data used for processing. The CPU 21 performs the processing described before by executing the program by using the memory 22. The storage device 25 is, for example, a magnetic disk device, an optical disk device, a magneto-optical disk device or the like. The program and data described above are stored in this storage device 25, and they are loaded to the memory 22 and used as necessary. The program and data are a program and data for realizing the embodiments described before, which execute the processing of the flowcharts shown in FIGS. 5, 16, 17 and 26 described before.

The medium driving device 26 drives a portable recording medium 29 and accesses the recorded contents. As the portable recording medium 29, any computer-readable recording medium is used, such as a memory card, memory stick, flexible disk, CD-ROM (compact disk read-only memory), optical disk, magneto-optical disk and DVD (digital versatile disk). It is also possible to store the program and data described above in this portable recording medium 29 and load them to the memory 22 to use them as necessary.

The network connection device 27 communicates with an external apparatus via any network (line) such as a LAN and a WAN and performs data conversion accompanying the communication. Furthermore, it can receive the program and data described above from the external apparatus and load them to the memory 22 to use them as necessary.

According to the embodiments, by using a model to which basic shapes associated with design intentions are applied, it is possible to easily judge whether or not to apply a basic shape and reduce confirmation man-hours. Furthermore, it is also possible to eliminate a fault in product design caused by utilizing a wrong basic shape. Furthermore, since a basic shape obtained by embodying a design intention can be provided directly, it is possible to easily cope with such a design know-how that digitization of a shape is difficult.

Though the description of the above embodiments relates to a shape design CAD system for an electronic apparatus, the present invention is not limited to the description of the above embodiments. For example, the present invention may be applied to a shape design CAD system for a transportation apparatus or a building. Furthermore, the present invention is applicable to a logical design CAD system for an electronic circuit, a wiring design CAD system for a printed-circuit board and a program design supporting CAD system, and is further applicable to a model design supporting CAD system and the like for UML (Unified Modeling Language) and the like.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention, the scope of which is defined in the claims and their equivalents.

What is claimed is:

1. A computer readable storage medium storing a program to cause a computer to operate as a design supporting apparatus and execute operations, the operations comprising:
extracting basic shape data associated with CAD model data;
extracting know-how data associated with the basic shape data; and
associating the model data with the know-how data and setting a degree of association between the model data and the know-how data.

2. The computer-readable recording medium according to claim 1, wherein the degree of association is set based on a number of the same kind of basic shape data associated with the model data.

3. The computer-readable recording medium according to claim 1, wherein, when the model data is read, the degree of association is updated.

4. The computer-readable recording medium according to claim 1, wherein the operations comprises:
displaying the know-how data based on the degree of association when referring to the model data.

5. The computer-readable recording medium according to claim 4, wherein, when the know-how data is displayed, know-how data with a higher association degree is displayed at a higher ranking, and know-how data with a lower association degree is displayed at a ranking lower than the higher ranking know-how data.

6. A design supporting apparatus, comprising:
a basic shape data extraction unit which extracts basic shape data associated with CAD model data;
a know-how extraction unit which extracts know-how data associated with the basic shape data; and
an association degree setting unit which associates the model data with the know-how data and sets a degree of association between the model data and the know-how data.

7. The design supporting apparatus according to claim 6, wherein the degree of association is set based on a number of the same kind of basic shape data associated with the model data.

8. The design supporting apparatus according to claim 6, wherein, when the model data is read, the degree of association is updated.

9. The design supporting apparatus according to claim 6, comprising:
a display unit which displays the know-how data based on the degree of association when referring to the model data.

10. The design supporting apparatus according to claim 9, wherein, when displaying the know-how data, the display unit displays know-how data with a higher association degree at a higher ranking, and know-how data with a lower association degree at a ranking lower than the higher ranking know-how data.

11. A method for supporting design, comprising:
extracting basic shape data associated with CAD model data;
extracting know-how data associated with the basic shape data; and
associating the model data with the know-how data and setting a degree of association between the model data and the know-how data.

12. The method according to claim 11, wherein the degree of association is set based on a number of the same kind of basic shape data associated with the model data.

13. The method according to claim 11, wherein, when the model data is read, the degree of association is updated.

14. The method according to claim 11, comprising:
displaying the know-how data based on the degree of association when referring to the model data.

15. The method according to claim 14, wherein, when the know-how data is displayed, know-how data with a higher association degree is displayed at a higher ranking, and know-how data with a lower association degree is displayed at a ranking lower than the higher ranking know-how data.

16. A computer-implemented method of supporting design, comprising:
associating shape data selected during design of a target model with know-how data stored from previous designs that use the shape data; and
ranking reasons for design decisions in the previous designs based on a condition and displaying the reasons according to said ranking.
